(19) United States
(12) Patent Application Publication
(10) Pub. No.: US 2008/0204527 A1
(43) Pub. Date: Aug. 28, 2008

(54) INK CARTRIDGE

(76) Inventor: Kenneth Yuen, San Gabriel, CA (US)

Correspondence Address: MERCHANT & GOULD PC, P.O. BOX 2903, MINNEAPOLIS, MN, 55402-0903, US

(21) Appl. No.: 11/680,435

(22) Filed: Feb. 28, 2007

(51) Int. Cl. B41J 2/175

(52) U.S. Cl. 347/86

(57) ABSTRACT

An ink cartridge including a housing, a plurality of ink outlets, and a plurality of air vent arrangements. The housing includes top and bottom walls, front and rear walls, first and second side walls, and a plurality of reservoir partitions. The reservoir partitions each extend between the first and second side walls and are spaced apart at locations between the front and rear walls to define a plurality of parallel arranged ink reservoirs. The ink outlets are positioned on the bottom wall and are in ink flow communication with the ink reservoirs. The air vent arrangements are in air flow communication with the ink reservoirs.

### TECHNICAL FIELD

The present invention generally relates to ink containers, and more particularly relates to ink cartridges for use with ink jet printers.

### BACKGROUND

Ink jet printers are a popular form of printer used with computers and similar applications involving document printing or graphics preparation. Typical ink jet printers have replaceable ink cartridges. Different styles of ink cartridges have different ink flow arrangements. One ink flow arrangement includes a sealed ink chamber, wherein the ink chamber walls are flexible in order to be depressed under vacuum pressure conditions that are generated as ink flows out of the ink chamber. In this arrangement, a biasing force is sometimes applied to the ink chamber walls to ensure initiation of ink flow out of the cartridge. Another ink flow arrangement includes an ink chamber that is in air flow communication with an exterior of the ink chamber so that the ink maintains an internal atmospheric pressure condition. In this arrangement, air at atmospheric pressure is drawn into the ink chamber as ink flows out of the ink chamber.

A common issue in many ink cartridges is the tendency for ink to drip out of the ink outlet when the ink cartridge is not mounted in the ink jet printer. One solution for this problem is to add an ink absorbing material such as a foam product inside the ink chamber. The foam reduces ink pressure at the ink outlet thereby reducing incidence of undesired dripping ink. A related issue is the tendency for ink to overflow out of the ink outlet junction with the ink jet printer or out of the print head of the printer when the ink cartridge is mounted to the printer. The overflow of ink at the junction or the print head typically results from uncontrolled or excessive ink flow out of the ink outlet. The overflowing ink can damage the printer and cause printing problems during use of the printer.

Some types of ink cartridges have multiple internal chambers, wherein each chamber holds a different color of ink. The need to provide an ink outlet and an air inlet for each of the chambers in this type of ink cartridge can provide many design limitations for the ink cartridge, in particular when there is a standard printer interface that the ink cartridge must mate with.

### SUMMARY

The present disclosure relates to an ink cartridge that includes a housing, a plurality of ink outlets, and a plurality of air vent arrangements. The housing includes a plurality of partitions that define a plurality of ink reservoirs in the housing. The partitions are arranged in series with each other, thereby defining an arrangement of the ink reservoirs in series with each other. The partitions typically extend across the width of the housing and further extend from a top wall to a bottom wall of the housing. The ink outlets are typically positioned along the bottom wall of the housing. A separate ink outlet is in ink flow communication with one of the ink reservoirs. The air vent arrangements provide air flow communication with each of the ink reservoirs.

The above summary is not intended to describe each disclosed embodiment or every implementation of the inventive aspects disclosed herein. Figures in the detailed description that follow more particularly describe features that are examples of how certain inventive aspects may be practiced. While certain embodiments are illustrated and described, it will be appreciated that the invention/inventions of the disclosure are not limited to such embodiments.

### BRIEF DESCRIPTION OF THE DRAWINGS

FIG. 1 is a schematic perspective view of an example cartridge assembly in accordance with principals of the present disclosure.

FIG. 2 is a schematic front view of the cartridge assembly shown in FIG. 1.

FIG. 3 is a schematic rear view of the cartridge assembly shown in FIG. 1.

FIG. 4 is a schematic left side view of the cartridge assembly shown in FIG. 1.

FIG. 5 is a schematic right side view of the cartridge assembly shown in FIG. 1.

FIG. 6 is a schematic top view of the cartridge assembly shown in FIG. 1.

FIG. 7 is a schematic bottom view of the cartridge assembly shown in FIG. 1.

FIG. 8 is a schematic cross sectional view of the cartridge assembly shown in FIG. 2 taken along cross sectional indicators 8-8.

FIG. 9 is a schematic front view of the cartridge assembly shown in FIG. 1 with a sealing member secured to the front panel.

FIG. 10 is a schematic exploded perspective view of the cartridge assembly shown in FIG. 9.

FIG. 11 is a schematic cross sectional view of the cartridge assembly shown in FIG. 10 taken along cross sectional indicators 11-11.

FIG. 12 is a schematic front view of the housing of the cartridge assembly shown in FIG. 1.

FIG. 13 is a schematic bottom view of the housing shown in FIG. 12.

FIG. 14 is a schematic right side view of the housing shown in FIG. 12.

FIG. 15 is a schematic perspective view of the housing shown in FIG. 12.

FIG. 16 is a schematic front view of a lid of the cartridge assembly shown in FIG. 1.

FIG. 17 is a schematic rear view of the lid shown in FIG. 16.

FIG. 18 is a schematic top view of the lid shown in FIG. 16.

FIG. 19 is a schematic bottom view of the lid shown in FIG. 16.

FIG. 20 is a schematic right side view of the lid shown in FIG. 16.

FIG. 21 is a schematic left side view of the lid shown in FIG. 16.

While the inventive aspects of the present disclosure are amenable to various modifications and alternate forms, specific embodiments thereof have been shown by way of example in the drawings, and will be described in detail. It should be understood, however, that the intention is not to limit the inventive aspects to the particular embodiments described. On the contrary, the intention is to cover all modifications, equivalents, and alternatives falling within the spirit and scope of the inventive aspects.

### DETAILED DESCRIPTION

The present disclosure relates to replaceable ink containers that provide ink to a print head of an ink jet printer. The ink container, also referred to as an ink cartridge, includes a housing that defines an ink reservoir, an air vent in air flow communication with the ink reservoir, and an ink outlet in ink flow communication with the ink reservoir. The housing defines at least three ink chambers configured to hold different colored ink. A plurality of partitions are positioned in the housing to define the different ink chambers. The partitions each extend across a width of the housing. The partitions are spaced apart along a length of the housing. The width dimension of the cartridge is typically less than the length dimension of the cartridge.

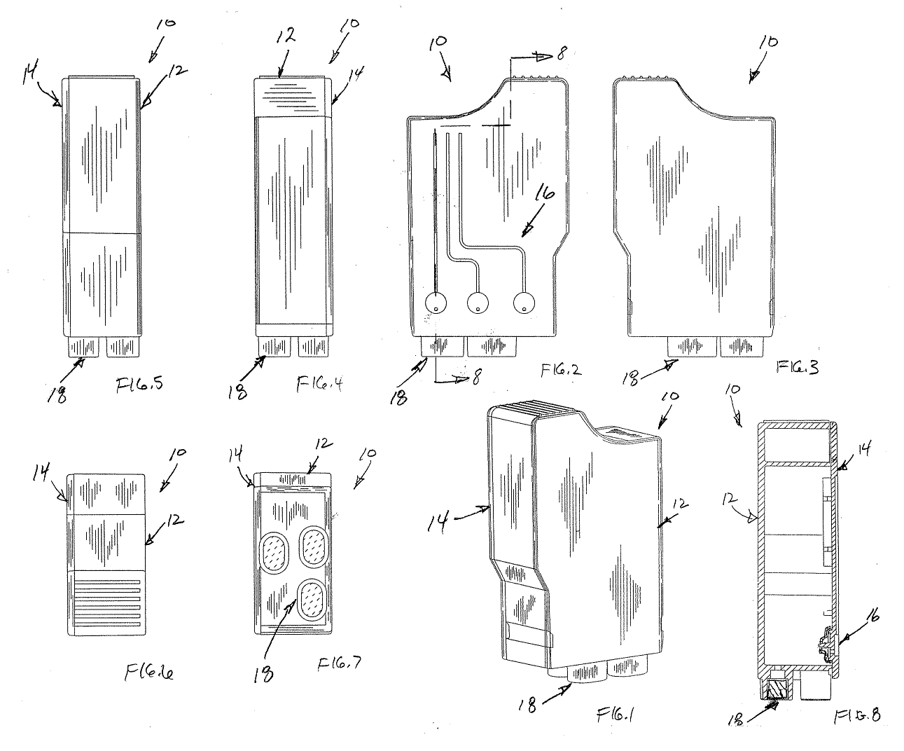

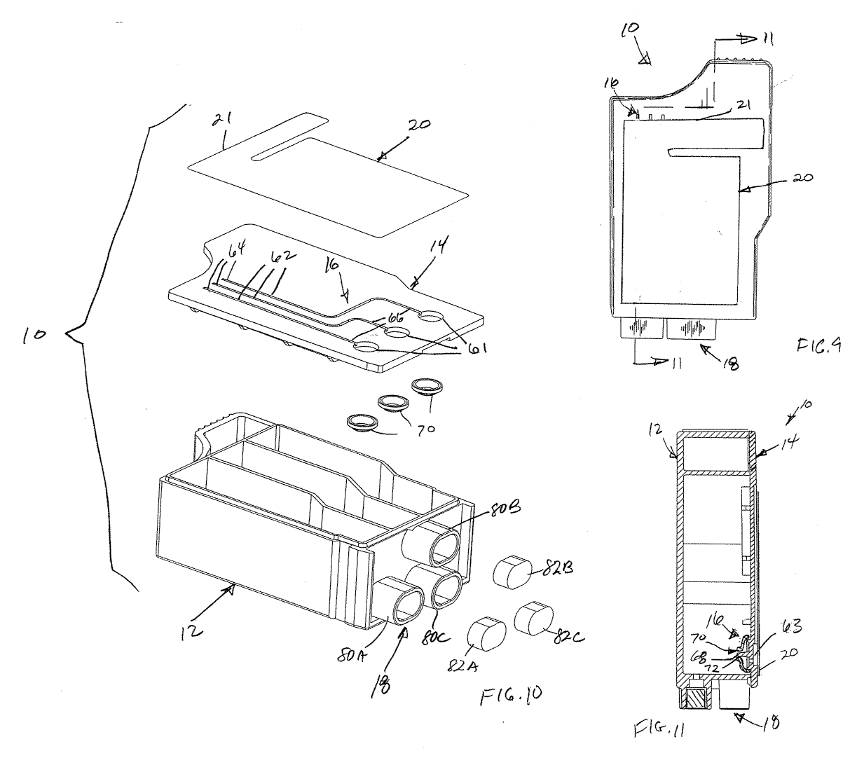

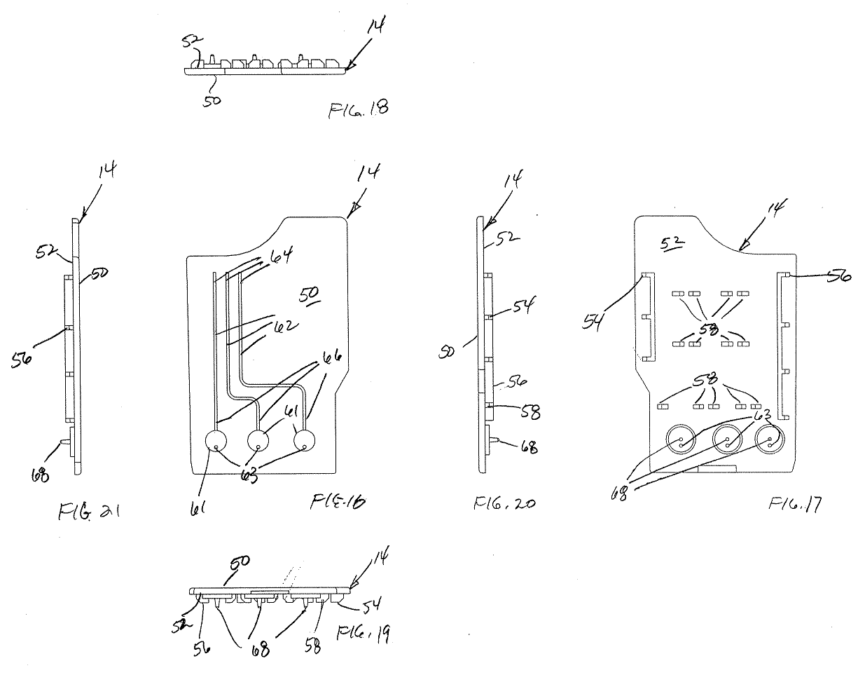

### EXAMPLE OF FIGURES 1-21

Referring first to FIGS. 1-11, an example cartridge assembly 10 is shown and described. The cartridge assembly 10 includes a housing 12, a lid 14, an air vent arrangement 16, an ink outlet arrangement 18, and a sealing member 20 (see FIGS. 9-11). The cartridge assembly 10 is configured for use in an ink jet printer. When the cartridge assembly 10 is mounted to the printer via, for example, a printer cartridge bay or printer cartridge carrier, ink is drawn from the housing 12 via the ink outlet arrangement 18 to provide a source of ink to the print heads of the printer.

The housing 12 includes front and rear panels 22, 24, a first side panel 26, and top and bottom panels 30, 32. The housing 12 further defines a second side surface 28 configured for engagement to the lid 14. The housing 12 also includes a handle 44 positioned on the top panel 30 that is used for handling the cartridge assembly (e.g., inserting or removing the cartridge assembly 10 relative to the printer).

A pair of first and second partitions 34, 36 are positioned within the housing 12. The partitions 34, 36 extend from the top panel 30 to the bottom panel 32 and from the first side panel 26 to the second side surface 28. The panels 22, 24, 26, 30, 32 together with the partitions 34, 36 define a plurality of parallel arranged ink reservoirs 38A-C. The ink reservoirs 38A-C are fluidly separated from each other when the lid 14 is sealingly engaged with the second side surface 28 of the housing 12. Typically, each of the ink reservoirs 38A-C holds a different color of ink for use in the printer. The partitions 34, 36 are positioned as shown in broken line in FIG. 13 relative to the ink outlet arrangement 18 such that a separate one of the ink outlets 84A-C (described below) is associated with each of the reservoirs 38A-C.

The partitions 34, 36 can have a variety of shapes and sizes. The partitions 34, 36 shown in the Figures have an upper portion 35 and a lower portion 37 (see FIG. 12) that are arranged generally vertically within the housing 12, but that are offset from each other in the length dimension of the housing 12. In other arrangements, the partitions 34, 36 can have different configurations from each other. Preferably, the partitions 34, 36 are configured and arranged in the housing 12 to provide at least three ink reservoirs that are arranged in series with each other along the length of the housing regardless of the position of the ink outlet openings 84A-C. The number of partitions used to define the ink reservoirs within the housing 12 can also vary from the two partitions 34, 36 shown in the Figures. For example, three or more partitions can be used to define the desired number of ink reservoirs. In some arrangements, a single continuous partition member can be used to define two or more ink reservoirs in the housing 12.

The ink reservoirs 38A-C are arranged in series with each other between the front and rear panels 22, 24. The dimension between the front and rear panels 22, 24 is the length dimension of the cartridge assembly 10. The arrangement of the ink reservoirs 38A-C can also be defined as being in line with each other along the length of the cartridge assembly 10. The ink reservoirs 38A-C can have different sizes and shapes that provide for a volume of the ink reservoirs 38A-C that is the same or different from each other as desired.

The housing 12 further includes latching grooves 40, 42 positioned on the front and rear panels 22, 24, respectively. The latching grooves 40, 42 can be used to help releaseably retain the cartridge assembly 10 within the printer (e.g., within a printer cartridge bay of the printer). Other connection features such as tabs, protrusions, latches, and other grooved structures can be used on or in the cartridge assembly 10 to facilitate removable mounting of the cartridge assembly 10 in a printer.

The lid 14 as shown in FIGS. 8-11 and 16-21 includes a front surface 50, a rear surface 52, outer wall connectors 54, 56, and a plurality of partition connectors 58. The front surface 50 faces outwardly away in a direction opposite the ink reservoirs 38A-C when the lid 14 is mounted to the housing 12 at the second side surface 28. The rear surface 52 is exposed to the ink reservoirs 38A-C. The outer wall connectors 54, 56 are positioned on the rear surface 52. The outer wall connectors 54, 56 are configured to engage portions of the front and rear panels 22, 24 of the housing 12 to provide a latching or locking connection between the housing 12 and lid 14. The partition connectors 58 are positioned on the rear surface 52 and are arranged to engage portions of the partitions 34, 36 to provide a positive attachment or connection between the lid 14 and housing 12. Adhesives, welding, and other types of connection materials can be used in place of or in addition to the connectors 54, 56, 58 to provide the positive connection and a fluid seal between the housing 12 and lid 14.

An internal volume of the handle 44 can be flow communication with one or more of the ink reservoirs 38A-C, thereby providing an increased ink volume capacity for the cartridge assembly 10. In some arrangements, the handle 44 is formed as a separate piece from the housing 12 and lid 14, and secured to the housing 12 and lid 14 in a separate assembly step. In other arrangements, the handle 44 is integral with the housing 12 or lid 14.

The air vent arrangement 16 is shown in at least FIGS. 2, 9-11 and 16-21. The air vent arrangement 16 includes air vents 60A-C. Each of the air vents 60A-C includes an air chamber 61 defined in the front surface 50 of the lid 14, and air aperture 63 providing fluid communication between the front and rear surfaces 50, 52 of the lid 14. An air channel 62 having upper and lower portions 64, 66 is positioned on the panels 22, 24, 26 of the housing 12 or on the lid 14. The air channel 62 is in air flow communication with the air chamber 61. An air valve assembly is positioned near the bottom panel 32 and is exposed to the volume of ink in the housing 12. The air valve assembly includes a diaphragm post 68 and a diaphragm 70 having a diaphragm opening 72 that is in alignment with the diaphragm post 68.

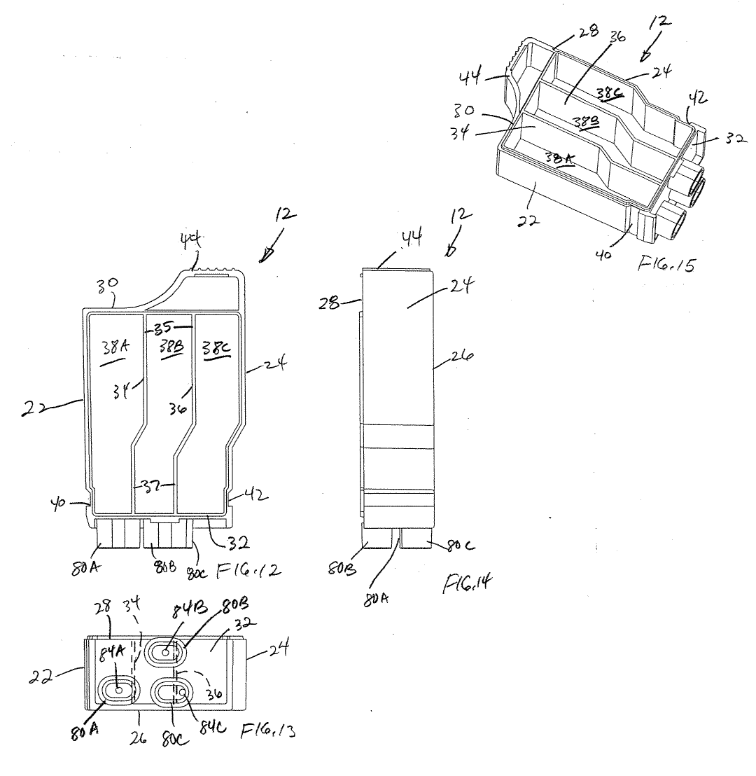

The valve assembly acts as a one-way valve that provides air flow from the air chamber 61 to the ink reservoirs 38A-C. The diaphragm 70 is positioned on the rear surface 52 of the lid 14 with the diaphragm opening 72 aligned and in engagement with the diaphragm post 68 (see FIGS. 8 and 11). When a negative pressure condition exists within one of the ink reservoir 38A-C associated with the particular valve assembly, and the negative pressure condition meets or exceeds a threshold pressure level, the diaphragm 70 is drawn away from the diaphragm post 68 thereby permitting air flow through the air aperture 63, the diaphragm opening 72, and into the ink reservoir. When the pressure level within the ink reservoir lowers below the threshold pressure level, the diaphragm 70 moves back to a rest state in which the diaphragm opening 72 is sealed closed against the diaphragm post 68. This function of the valve assembly provides a one-way air flow path into the ink reservoir while prohibiting the flow of ink held within the ink reservoir back into the diaphragm 70 and air chamber 61. Other valving structures besides a one-way diaphragm valve can be used with the air vent arrangement 16 described herein to provide the desired air flow into the ink reservoirs 38A-C.

The air vents 60A-C operate to provide a minimum negative pressure condition within the ink reservoirs 38A-C such that ink is prevented from inadvertently dripping from the ink outlet arrangement 18 prior to or after mounting of the cartridge assembly 10 to the ink jet printer. This minimum negative pressure condition is generated by providing an air inlet into the ink reservoirs 38A-C near the bottom panel 32 and providing an air inlet into the air vent 60A-C that is at or above a maximum ink level within the ink reservoirs 38A-C. To provide an air inlet to the air vents 60A-C that is at such a vertical height on the cartridge assembly 10, the sealing member 20 is used to seal off the air chamber 61 and air channel 62 from air flow communication except at the upper portion 64 of the air channel 62. A top edge 21 of the sealing member 20 is positioned vertically below the uppermost end of the air channel 62 such that the upper portion 64 of the air channel 62 is exposed to provide air flow communication into the air channel 62 (see FIGS. 9 and 11). In this arrangement, the air channels 62 and air chamber 61 are positioned on the front surface 50 of the lid 14. In other arrangements, portions of the air chamber 61 and air channel 62 can be positioned on the rear surface 52. Further, this arrangement uses a sealing member 20 to cover the air chamber 61 and most of the air channel 62. In other arrangements, different structures rather than an open channel in combination with a sealing member can be used to provide an air flow path from an upper portion of the ink reservoirs 38A-C to a bottom portion of the ink reservoirs 38A-C. A variety of air venting arrangements are shown and described in Applicant's co-pending application Ser. No. 11/620,452 filed on Jan. 5, 2007 and entitled FLUID FLOW ARRANGEMENTS FOR INK CARTRIDGE, which is incorporated herein by reference.

The ink outlet arrangement 18 includes ink receivers 80A-C, a plug or wick 82A-C associated with each of the ink receivers 80A-C, and an ink outlet opening 84A-C associated with each of the ink receivers 80A-C. As shown in FIGS. 7 and 13, the ink receivers 80A-C are positioned at spaced apart locations along the bottom panel 32 of the housing 12. The relative positioning of the ink receivers 90A-C is generally fixed for the cartridge assembly 10 so as to arrange with ink communication members positioned on the printer. The ink outlet openings 84A-C are positioned within the ink receiver 80A-C along the bottom panel 32 at a location to provide ink flow communication with the ink reservoirs 38A-C. Thus, the positioning of the partitions 34A-C within the housing 12 along with the modified positioning of the ink outlet openings 84A-C provides the ability to arrange the ink reservoirs 38A-C in series with each other between the front and rear panels 22, 24 of the housing 12.

Portions of the cartridge assembly 10 can comprise a variety of materials. For example, the housing 12 and lid 14 can comprise a material that does not have adverse interactions with the ink held in the ink reservoirs 38A-C (e.g., chemical reaction that results in corrosion, pitting, etc.). Some example materials that meet these requirements include polypropylene (PP) and polyethylene (PE), which has inert properties. The process of forming portions of the cartridge assembly 10, such as the housing 12 and lid 14 can include a molding or costing process using a moldable or castable material. While the examples illustrated in the attached Figures provide for separate housing 12 and lid 14 features, with the lid 14 defining a side wall of the resultant cartridge assembly 10, other configurations provide for a single piece housing or a lid member that defines a different wall of the cartridge assembly (e.g., a front, rear, top, or bottom wall of the cartridge assembly).

### Conclusion

One aspect of the present disclosure relates to a printer ink cartridge that includes a housing, a plurality of ink outlets, and a plurality of air vent arrangements. The housing includes top and bottom walls, front and rear walls, first and second side walls, and a plurality of reservoir partitions. The reservoir partitions each extend between the first and second side walls and the top and bottom walls. The reservoir partitions are spaced apart at locations between the front and rear walls to define at least three parallel ink reservoirs. The ink outlets are positioned on the bottom wall and provide ink flow communication with one of the ink reservoirs. The air vent arrangements each include an upper air inlet positioned adjacent the top wall of the housing and a bottom air inlet adjacent the bottom wall of the housing to provide air flow communication with the ink reservoirs.

Another aspect of the present disclosure relates to a printer ink cartridge having a housing. The housing includes first and second opposed walls, third and fourth opposed walls, and top and bottom opposed walls. The first, second, third and fourth walls extend between the top and bottom walls. A plurality of reservoir partitions extend between the third and fourth walls and between the top and bottom walls. The partitions are spaced apart at locations between the first and second walls to define a plurality of ink reservoirs arranged in series with each other. The ink reservoirs are fluidly separated from each other.

A still further aspect of the present disclosure relates to a method of manufacturing a printer ink cartridge. The method includes molding a cartridge housing, wherein the cartridge housing includes top and bottom walls, front and rear walls, first and second side walls, a plurality of reservoir partitions, and a plurality of ink outlets. The reservoir partitions each extend between the first and second side walls and between the top and bottom walls. The reservoir partitions are spaced apart at locations between the front and rear walls to define a plurality of ink reservoirs. The ink outlets are positioned on the bottom wall, wherein each ink reservoir is in ink flow communication with one of the ink outlets. The method can further include positioning an air vent arrangement on the cartridge housing, wherein the air vent arrangement includes an air vent into each of the ink reservoirs.

The above specification provides examples of how certain inventive aspects may be put into practice. It will be appreciated that the inventive aspects can be practiced in other ways than those specifically shown without departing from the spirit and scope of the inventive aspects.

We claim:

1. A printer ink cartridge, comprising:
a housing including top and bottom walls, front and rear walls, first and second side walls, and a plurality of reservoir partitions, the reservoir partitions each extending between the first and second side walls and being spaced apart at locations between the front and rear walls to define at least three parallel ink reservoirs; and
at least three ink outlets positioned on the bottom wall, each ink reservoir being in ink flow communication with one of the ink outlets.

2. The printer ink cartridge of claim 1, further comprising at least three air inlets, each ink reservoir being in air flow communication with one of the air inlets, each air inlet include a one-way air valve.

3. The printer ink cartridge of claim 1, wherein a length dimension of the housing measured between the front and rear walls is greater than a width dimension of the housing measured between the first and second side walls of the housing.

4. The printer ink cartridge of claim 1, wherein the at least three ink outlets are spaced apart along the bottom wall at offset locations between the first and second side walls of the housing.

5. The printer ink cartridge of claim 1, wherein the wherein the at least three ink outlets are spaced apart along the bottom wall at offset locations between the front and rear walls of the housing.

6. The printer ink cartridge of claim 1, further comprising a plurality of air vent arrangements, each air vent arrangement including an upper air inlet positioned adjacent the top wall of the housing and a bottom air inlet adjacent the bottom wall of the housing, each ink reservoir being in air flow communication with one of the bottom air inlets.

7. The printer ink cartridge of claim 1, wherein one of the side walls is configured as a removable lid member.

8. The printer ink cartridge of claim 1, wherein at least one of the reservoir partitions includes an upper portion and a lower portion, wherein the upper and lower portions are positioned offset from each other relative to the front and rear walls of the housing.

9. A printer ink cartridge, comprising:
a housing including first and second opposed walls, third and fourth opposed walls, top and bottom opposed walls, and a plurality of reservoir partitions, the first, second, third and fourth walls extending between the top and bottom walls, the reservoir partitions each extending between the third and fourth walls and between the top and bottom walls, the reservoir partitions being spaced apart at locations between the first and second walls to define a plurality of ink reservoirs arranged in series with each other, the ink reservoirs being fluidly separated from each other.

10. The printer ink cartridge of claim 9, further comprising a plurality of ink outlets positioned on the bottom wall, each ink reservoir being in ink flow communication with one of the ink outlets.

11. The printer ink cartridge of claim 9, further comprising at least three air inlets, each ink reservoir being in air flow communication with one of the air inlets, each air inlet including a one-way air valve.

12. The printer ink cartridge of claim 9, wherein a length dimension of the housing measured between the first and second walls is greater than a width dimension of the housing measured between the second and third walls of the housing.

13. The printer ink cartridge of claim 10, wherein the at least three ink outlets are spaced apart along the bottom wall at offset locations between the second and third walls of the housing.

14. The printer ink cartridge of claim 10, wherein the wherein the at least three ink outlets are spaced apart along the bottom wall at offset locations between the first and second walls of the housing.

15. The printer ink cartridge of claim 9, further comprising a plurality of air vent arrangements, each air vent arrangement including an upper air inlet positioned adjacent the top wall of the housing and a bottom air inlet adjacent the bottom wall of the housing, each ink reservoir being in air flow communication with one of the bottom air inlets.

16. The printer ink cartridge of claim 11, wherein the one-way valves include a diaphragm valve.

17. The printer ink cartridge of claim 9, wherein one of the side walls is configured as a removable lid member.

18. A method of manufacturing a printer ink cartridge, comprising:
molding a cartridge housing, the cartridge housing including top and bottom walls, front and rear walls, first and second side walls, a plurality of reservoir partitions, and a plurality of ink outlets, the reservoir partitions each extending between the first and second side walls and between the top and bottom walls, the reservoir partitions being spaced apart at locations between the front and rear walls to define a plurality of ink reservoirs, the ink outlets positioned on the bottom wall, each ink reservoir being in ink flow communication with one of the ink outlets.

19. The method of claim 18, wherein molding the cartridge housing includes molding a removable lid member, the lid member defining one of the walls of the cartridge housing.

20. The method of claim 18, further comprising positioning an air vent arrangement on the cartridge housing, the air vent arrangement including an air vent into each of the ink reservoirs, the air vent being positioned adjacent the bottom wall.
